(19) United States
(12) Patent Application Publication
(10) Pub. No.: US 2018/0047108 A1
(43) Pub. Date: Feb. 15, 2018

(54) METHOD AND SYSTEM FOR SEAMLESSLY PROPAGATING AN INVENTORY OF POSSESSIONS AND AUTOMATING INSURANCE CLAIMS

(71) Applicant: TOOLLOGO LLC, Easton, CT (US)

(72) Inventors: Franklin R. Silverstone, Easton, CT (US); Serge Meynard, Montreal (CA); Linda Zarnon, Montreal (CA)

(21) Appl. No.: 15/667,793

(22) Filed: Aug. 3, 2017

Related U.S. Application Data
(60) Provisional application No. 62/373,141, filed on Aug. 10, 2016.

(51) Int. Cl. G06Q 40/08; G06F 3/048; G06Q 10/08

(52) U.S. Cl. CPC G06Q 40/08; G06Q 10/0875; G06F 3/048

(57) ABSTRACT

Provided is a closed-loop system and method for the seamless population to a customer's inventory management software of information regarding things purchased from a vendor. In the case of loss, damage or theft of the purchased thing(s), this system and method allows for the automation of an insurance claim and possible replacement of thing(s) from the original vendor.

### FIELD OF THE INVENTION

The invention relates to facilitating the seamless population of information regarding purchased things from a merchant to a customer's Inventory Management Software (IMS), and, in the case of loss, damage or theft of the purchased things, automation of an insurance claim and possible replacement of things from the original merchant.

### BACKGROUND OF THE INVENTION

Maintaining an inventory of one's possessions is a painstaking task at best. According to the most recent survey by the National Association of Insurance Commissioners in 2012, 59 percent of consumers have not made any list or inventory of their possessions and/or valuables. This is an issue because in the early part of 2016, journalists reported that 60 million Americans were affected in some way by the natural disasters that hit parts of the United States. These facts alone point to the conclusion that very few of those who lost property were adequately insured and therefore most were unable to be compensated fully or at all for their losses.

Even those with inventories can be at risk. The same 2012 survey revealed that of those with inventories: 48 percent have no receipts; 27 percent have no photos; 28 percent have no offsite back-up copy of their inventory data; and 59 percent have not updated their inventory with new purchases and gifts in over a year.

Many people cannot remember all the things in their living room, the number of shoes in their closet, of the serial number of their television. Nowadays, keeping an inventory of such information is crucial in the case of loss, theft or damage to one's personal belongings, collections and home. When filing a claim, the insurance carrier will require proof of ownership to show that the thing(s) were actually owned. Documents, receipts, updated valuations, or photos will assist in substantiating a claim. Without some or all of these, processing a claim will be a long, drawn out and difficult process.

Although there are several ways to make a list of possessions, the most complete is to use an inventory software program that can store receipts, images, insurance policies, valuations, warranties, manuals and other vital information. The software can also allow the user to keep track of other information such as, but not limited to, profits and losses when selling objects, the location of objects, and emergency plans in case of disaster. The software can also facilitate the distribution of belongings to beneficiaries, not just what things are to be gifted, but also when they are to be disbursed. A copy of the inventory can also easily be stored for safekeeping outside of the home, in either a physical or virtual location.

To date, the major drawback of using such a software program, as with most software, is that the data must be entered manually. People eagerly begin cataloguing their belongings, but often lapse when they find themselves having to import photos and receipts, add in descriptions, costs, and other associated information for hundreds of things. The amount of work involved presents a daunting task few would wish to undertake.

Most people don't want to spend any of their free time managing their inventory, and while they will often take an “it won't happen to me” attitude, most Americans will face the possibility of having to file an insurance claim at some point in their lives. Both the insurance carriers and the claimant will benefit greatly when an accurate inventory is available as it will streamline the claims process. In addition, should the claimant wish to replace what was lost, the information contained in the IMS will allow the carrier to facilitate the replacement process immediately.

Thus, there is a need for an automated system that will download all available information about an object to a user's inventory. Whether the purchase is an appliance, furniture, decorations, jewels, collections, even clothes, shoes and linens, this invention will allow all pre-gathered information collected from each purchase to be seamlessly migrated into the user's inventory software.

### SUMMARY OF THE INVENTION

An objective of the invention is to provide a method and system to automatically create an inventory of a user's things.

Another objective of the invention is to provide an automated insurance claim for loss of the user's things.

The present invention removes as much of the human aspect of data entry as possible by automating the population of information related to purchased things directly into the inventory software itself. With this proposed method, the inventory process allows for information regarding the things, such as purchase and product information, to be entered into a customer's inventory management system by the click of a button. Therefore, the time required to keep and maintain an inventory of belongings is greatly reduced.

As an example, the user purchases a new television using a credit card. The merchant provides a paper receipt which contains a QR code. The purchaser scans the QR code using a mobile device, which automatically downloads all pertinent information about the purchase directly into the inventory management software (IMS). This information can also be obtained directly from the credit card company's monthly statement or by accessing transaction information online during the current statement cycle.

The information dowloaded into the inventory software about the television can include, but is not limited to, the merchant name, address and contact number, the make and model of the thing, the serial number, a brief description of the computer, the purchase price, warranty information, an electronic copy of the receipt, and the user manual.

Examples of the invention create a closed loop for many services, in particular the insurance industry. In the event of a claim, the client can identify all things in question and instantly generate a claims report for the insurance carrier. The claim generated can include, but is not limited to, information such as the claimant's name and policy number, a description, an image of the thing, the model number, the purchase price, the merchant contact information, and date of purchase of the thing. The claim can then be delivered electronically to the customer's Insurance carrier or agent. If the insurance carrier does not support electronic claims, or if the carrier requires electronic delivery using a different method, the customer can still use the information from the IMS by exporting or transcribing the information. The insurance carrier can then use the additional claim details received to expedite processing of the insurance claim and, upon instructions from the claimant, replace the thing through the original point of purchase.

Various aspects of the described example embodiments can be combined with aspects of certain other example embodiments to realize yet further embodiments. It is to be understood that one or more features of any one example can be combined with one or more features of the other example. In addition, any single feature or combination of features in any example or examples can constitute patentable subject matter. Other features of the technology will be apparent from consideration of the information contained in the following detailed description.

### BRIEF DESCRIPTION OF THE DRAWINGS

The following Detailed Description can be better understood when read in conjunction with the appended drawings. For the purposes of illustration, the drawings show example embodiments, but the subject matter is not limited to the specific elements and instrumentalities disclosed.

FIG. 1 illustrates an example data flow of the present invention, from a transaction to an Inventory Management Software.

FIG. 2 illustrates an example of creating and publishing a transaction record.

FIG. 3 illustrates an example of the population of a transaction record through a paper receipt produced by a merchant POS terminal.

FIG. 4 illustrates an example of the population of a transaction record through an electronic receipt produced by a merchant POS terminal.

FIG. 5 illustrates an example of the IMS accessing a transaction record from a TDS.

FIG. 6 illustrates an example of the IMS receiving a transaction link for a transaction record or transaction record group from a credit card company.

FIG. 7 illustrates an example of the IMS accessing a Thing Record from a TIS.

FIG. 8 illustrates an example list of data fields that can be found in a transaction record.

FIG. 9 illustrates a sample QR code encoding a transaction link.

FIG. 10 illustrates an example list of data fields that can be found in an electronic claim.

FIG. 11 illustrates an example of the transfer of an insurance claim from the IMS to the insurance carrier's Server.

FIG. 12 illustrates an example of possible fields contained in the IMS and additional services that would benefit from the information therein contained.

FIG. 13 illustrates an example system.

FIG. 14 illustrates a screenshot of a paper receipt with a QR code embedded in it.

FIG. 15 illustrates a screenshot of a home page of a home inventory software application.

FIG. 16 illustrates a screenshot the application capturing information on a receipt QR code.

FIG. 17 illustrates a screenshot of a list of purchased items downloaded from the receipt QR code, using the device QR code reader.

FIG. 18 illustrates a screenshot of an Item List after import has been confirmed.

FIG. 19 illustrates a screenshot of an Item List.

FIG. 20 illustrates a screenshot of a selection and deletion of items not to be inventoried.

FIG. 21 illustrates a screenshot of an updated Item List.

FIG. 22 illustrates a screenshot of assigning a room to an item by clicking on “Assign Room”.

FIG. 23 illustrates screenshot of a pop-up window, listing rooms from which to make a selection for the chosen item.

FIG. 24 illustrates a screenshot of selecting “Garage” and clicking on “Set” assigns the room “Garage” for the selected item from the list shown in FIG. 23.

FIG. 25 illustrates a screenshot of an unsorted Item List.

FIG. 26 illustrates a screenshot of items sorted by room.

FIG. 27 illustrates a screenshot of items sorted by category.

FIG. 28 illustrates a screenshot of a selection of “make a claim” icon from the home page.

FIG. 29 illustrates a screenshot of a Claim Form.

FIG. 30 illustrates a screenshot of selected items to be claimed from the Item List.

FIG. 31 illustrates a screenshot of a Claim Form on which two items are being claimed.

FIG. 32 illustrates a screenshot of a confirmation for an electronically submitted Claim Form.

FIG. 33 illustrates a screenshot of a Saved Claims page.

FIG. 34 illustrates a flow chart of an example method according to the present invention.

### DETAILED DESCRIPTION OF THE INVENTION

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention. However, it will be apparent to one skilled in the art that the present invention can be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention. All use of the word “example” are intended to describe non-limiting examples of the invention.

The invention will now be explained with reference to the attached non-limiting Figs. The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

To facilitate an understanding of the principles and features of the various embodiments of the present invention, various illustrative embodiments are explained below. Although example embodiments of the present invention are explained in detail, it is to be understood that other embodiments are contemplated. Accordingly, it is not intended that the present invention is limited in its scope to the details of construction and arrangement of components set forth in the following description or examples. The present invention is capable of other embodiments and of being practiced or carried out in various ways.

As used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the example embodiments, terminology will be resorted to for the sake of clarity. It is intended that each term contemplates its broadest meaning as understood by those skilled in the art and includes all technical equivalents that operate in a similar manner to accomplish a similar purpose.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified. Such other components or steps not described herein can include, but are not limited to, for example, similar components or steps that are developed after development of the disclosed technology.

As illustrated, lines or arrows between elements can denote communications between the different elements. These communications can take any form known by those of skill in the art, including digital, telephonic, or paper. The communications can be through a WAN, LAN, analog phone line, etc. The information communicated can be in any format appropriate for the transmission medium.

“Thing” is a generic term to denote any item, physical or otherwise, which can be owned or purchased. The term thing includes any item which can be afforded replacement protection through the services of an insurance provider.

“Thing record” refers to a structured set of data containing generic information about a Thing. The exact format of a Thing Record can vary depending on the specific Thing information service which provides the Thing Record.

“Thing information service (TIS)” can be an internet-based or other networked service which provides storage for and access to Thing Records.

“Thing link” can be a web hyperlink, leading to a TIS, through which a specific Thing Record can be accessed.

“Transaction UID” refers to a globally-unique ID, which is assigned to every transaction record and can be used as a key to retrieve a transaction record from a TDS.

“Transaction record” refers to a structured set of data containing the details of a customer transaction. The details can be provided as collected by the merchant or credit card company. A transaction record can include a Thing link for any or all things in the transaction. In some example embodiments, transaction records can be encrypted to protect the privacy of their contents. In some example embodiments, transaction records can be allowed to expire based on time- or access-related policies. Each transaction record is uniquely identified by its transaction UID, and can include one or more of the following: a transaction date, merchant information, amount payed and information for each purchased thing in the transaction, among other possibilities.

“Transaction database service (TDS)” can be an internet-based or other networked service which provides storage for and access to transaction records. A TDS can be managed by any number of providers (merchants, credit card companies, or other third parties). The TDS can be accessed through a secure connection, i.e. https.

“Transaction record group” refers to a group of transaction records that can be accessed as a unit using a transaction link. Each transaction record group-has its own separate transaction UID. Transaction record groups can simplify batch access to transaction data such as downloading all transactions in a credit card monthly statement.

“Transaction link” refers to a web hyperlink, leading to a TDS, through which a transaction record or transaction record group can be accessed. In some example embodiments, the key information embedded in the link can be encoded to prevent exposing the key information directly, and can incorporate identity-verification mechanisms.

“QR Code” (abbreviated from Quick Response Code) is the nomenclature for a matrix-type (or two-dimensional) barcode. A barcode is a machine-readable optical label that contains information about the thing to which the barcode is attached. QR Codes are often used to encode a web URL in a form easily scanned using a smartphone's integrated camera. Although they can contain arbitrary data, their storage capacity is limited and so they are best used to encode small amounts of data.

“Encoded transaction link” refers to a QR Code, or other similar electronically readable representation, which contains a transaction link. In some example embodiments, when transaction records are encrypted, the encoded transaction link can contain the decryption key required to access the encrypted information.

“FileType mapping” describes the process of associating a data file with a compatible software application using the file's type or name extension. FileType Mapping is a service provided by a computing device's operating system.

“Inventory management software (IMS)” is a software application which can be used to manage a person's Inventory data, in particular for insurance purposes. The IMS can include data storage and a processor, among other possibilities. Discussions with respect to each of them are provided below.

“Helper application” refers to an application, often available for free, which provides services that enhance the functionality of another application. The helper application typically operates in concert only with the main application for which the helper application was designed.

“Data storage” can be any one or a combination of a hard drive, random access memory, flash memory, read-only memory and a memory cache, among other possibilities. The data storage can include a non-transitory computer-readable medium. The data storage can include a database, implemented as relational database tables or structured XML documents or any other format. Such a database can be used to store the information gathered from transaction records and Thing Records.

“Processor” can refer to a single data processor on a single computing device or a collection of data processors. The collection of data processors can reside on a single computing device or be spread across multiple computing devices. The processor can execute computer program code stored in the data storage or a memory. In one example, the processor can execute computer program code representative of functionalities of various components of the system.

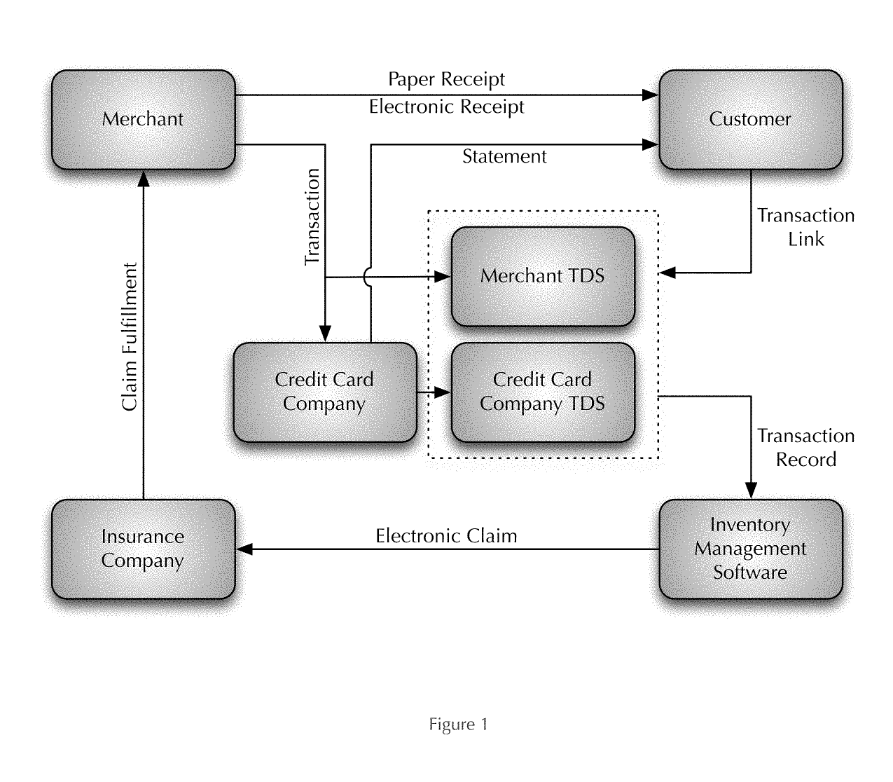

FIG. 1 is an example of the present invention to generate a transaction record for a thing purchased from a merchant. The transaction record is then transmitted to the customer's inventory management system. Should the thing be lost or stolen, the customer's IMS can generate and forward a claims report containing all essential information about the thing to the insurance carrier. The insurance carrier has the option to fulfill the claim from the original merchant where the thing was purchased. Illustrated is a system flow where a user/customer purchases a thing from a merchant. Here, the merchant can be a typical brick-and-mortar establishment or an e-commerce site. The transaction can be consummated in multiple ways: The customer can pay for the thing using any form of payment desired, such as credit, cash, debit, or mobile payment.

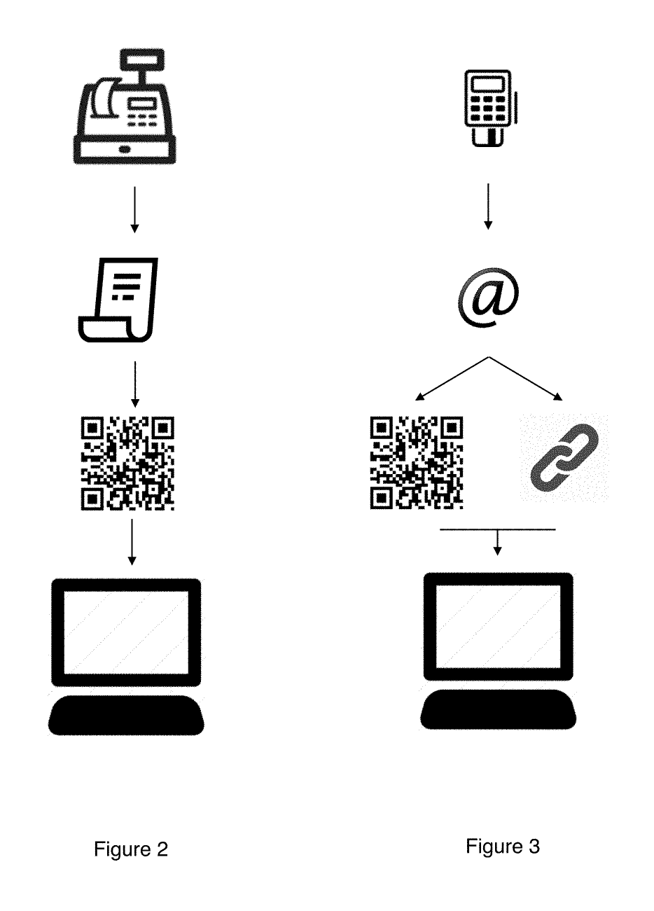

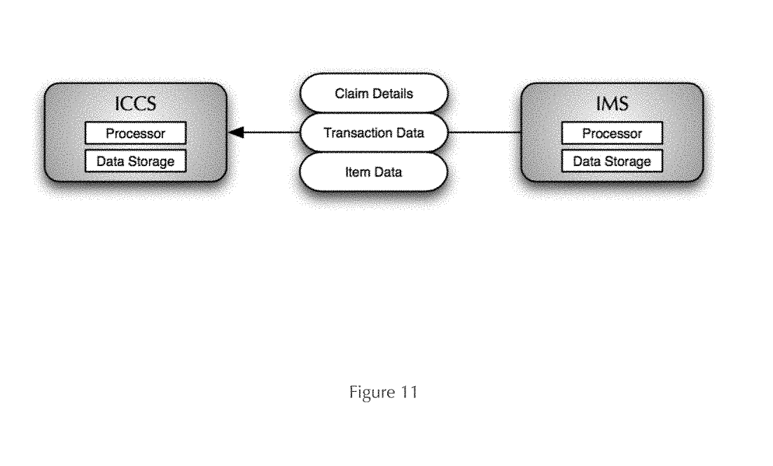

Regardless of the payment method, once the payment for a thing has been processed, transaction record information is generated by the merchant, whether by the Point of Sale (POS) terminal, the merchant's transaction servers, or some other means. FIG. 2 illustrates by way of example embodiment a system by which a transaction record is created and published, and a transaction link transferred to the customer. The merchant POS contains a processor and data storage, allowing the creation and transmittal of a transaction record. A transaction record contains a unique identifier (Transaction UID); this prevents duplicates of transaction records from being downloaded into the IMS, for example from the merchant's electronic receipt as well as from the customer's credit card statement described in more detail in FIG. 11.

In some instances, such as in an e-commerce setting or if a thing is back-ordered at a brick and mortar merchant, the exact thing is not available at the time of purchase. The particulars of the thing (e.g., the serial number) can be transmitted separately once the thing is designated for that particular customer. The merchant TDS can be updated with a revised transaction record based on the thing as designated for that customer if the complete set of information is not available at the time of the initial transaction. Managing multiple transaction records for the same thing is discussed further below.

The transaction record can be transmitted from the merchant POS software to the Transaction database service (TDS), an internet-based service which contains a data storage and processor providing storage for and access to transaction records. Said Transaction Database Service can be managed by, but is not limited to the merchant, the credit card company or a Third Party.

Whether in a brick and mortar or an e-commerce setting, the merchant can generate either a paper or electronic receipt for the customer. FIG. 3 illustrates by way of example embodiment a paper receipt produced by the merchant. The receipt can contain an Encoded transaction link, which can be a QR Code or other similar camera-readable representation which encodes the transaction link. The customer can scan the Encoded transaction link using a Helper Application (such as but not limited to a QR Code reader application specific to the customer's IMS) on his or her smartphone, computer or other user interface device. After extracting the transaction link, the Helper Application can either send the transaction link directly to the customer's IMS, which can then download the transaction record from the TDS, or the Helper Application can use the transaction link itself to download the transaction record from the TDS. In this case, the transaction record can be stored on the device and later transferred to the customer's IMS.

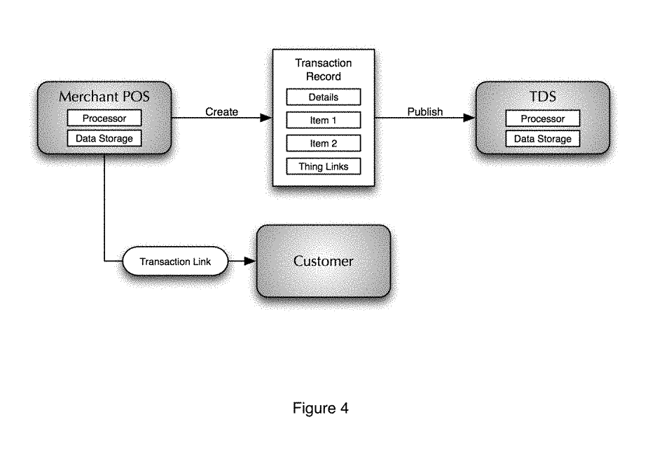

FIG. 4 illustrates by way of example embodiment an electronic receipt produced by the merchant. The receipt can include a QR Code containing an Encoded transaction link. In this case, the same methodology as for a paper receipt can be applied. The receipt can instead contain an attachment incorporating the transaction record itself; this attachment can be recognized by a smartphone, computer or other user interface device, and the transaction record can be transferred to the customer's IMS.

In addition to the merchant receipt, when a purchase is made using a credit card, the customer has alternative ways of accessing transaction information: either from the credit card company's monthly statement or by online access of transaction information during a current statement cycle. If given a transaction link, the credit card company can store the transaction link alongside the customer's other data and make the transaction link available at a later time as part of the statement or online services. The IMS collects the data in the transaction records, as well the associated thing records, from the TDS and then assembles them cohesively in its own storage. This is made possible by the fact that all components of this system, namely the TDS and TIS, use a standard format to transmit the information.

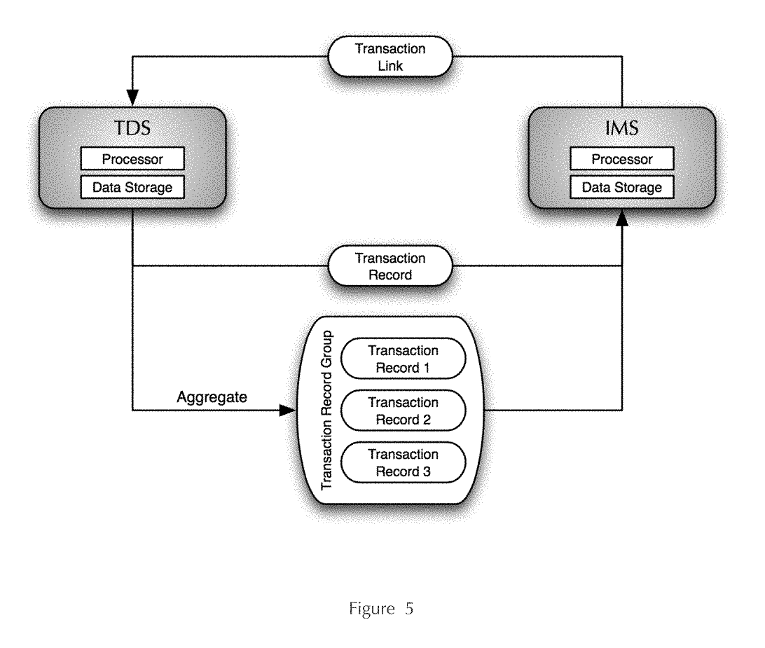

FIG. 5 illustrates by way of example embodiment the access and transfer of a transaction record or transaction record group to the customer's IMS using the transaction link as described in FIG. 2. The IMS, with its processor and data storage, uses the link to access the transaction record data on the TDS. In all cases where transaction records are downloaded into the customer's IMS, one or more options can be made available to exclude individual entries from the transaction record which are deemed irrelevant by the customer, e.g. consumables or other non-insurable things. The data can still be stored by the IMS in case the customer wishes to change the selection of things to be imported at a later point.

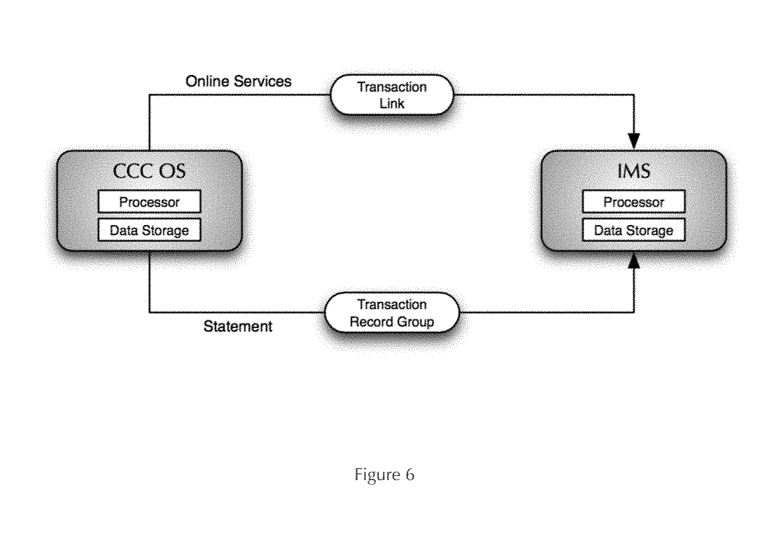

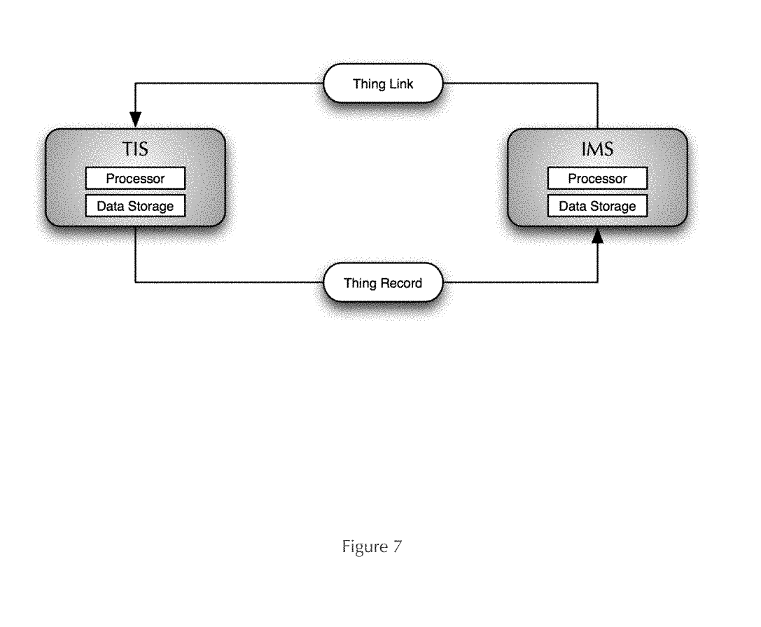

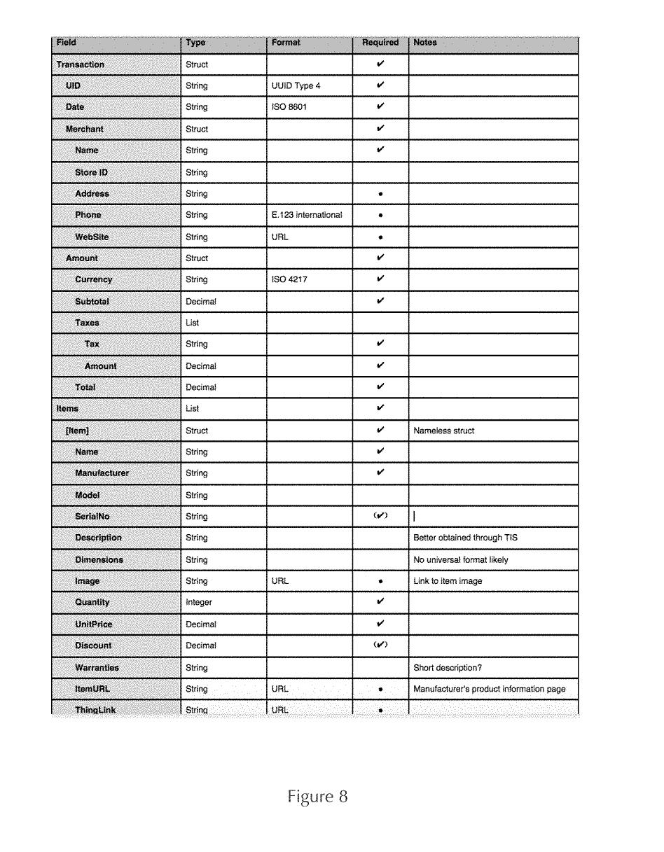

FIG. 6 illustrates by way of example embodiment a method for accessing transaction records for credit card purchases. The credit card company can receive from the merchant POS a transaction link, and can make this data available to the customer either as an attachment to an electronically delivered statement or through its online services. The same method as described in FIG. 4 can be used by the customer's IMS to access the transaction record.

FIG. 7 illustrates by way of example embodiment the access and transfer of Thing records to the customer's IMS. The IMS accesses the Thing information service (TIS) through a Thing link, which can be included in the transaction record. The TIS contains a processor and data storage, and is used to store generic information on any number of things. Thing records containing this generic information can then be transmitted to the customer's IMS.

In cases where a Thing link is not provided by a transaction record, equivalent information can also be accessed through alternate methods such as an internet keyword search by the user. Information obtained through this method can be imported or transcribed into the IMS.

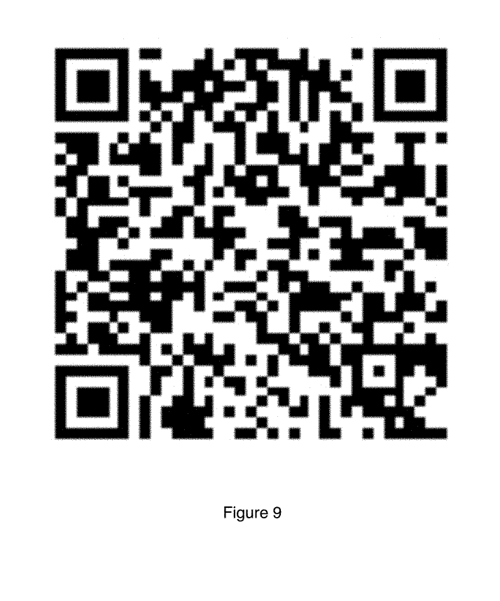

FIG. 8 illustrates by way of example embodiment a list of transaction record fields. Types of fields can include structured, strings, lists and decimals. Only some of the fields are required, but all should be provided whenever possible. A transaction record can contain, but is not limited to: date of purchase, time of purchase, merchant name, merchant address, store ID, merchant telephone number, merchant website; amount of purchase, currency subtotal, taxes, total; identification of Thing purchased, serial number of Thing, price of each Thing purchased, subtotal cost of Things purchased, applicable taxes on Things purchased, total cost of Things purchased, quantity of each Thing, unit price discount of each Thing, total number of Things purchased; payment method of Things purchased, and one or more Thing links. A Thing Record, accessed through a Think Link, can include, but is not limited to: warranty information, a web URL to an image of the thing, dimensions, and product URL.

FIG. 9 illustrates by way of example embodiment a QR code containing an encoded transaction link, such as https://www.some-tds.com/transact-record?id=05c8ba95-4946-43b3-8773-18da302b683f. By way of example, the transaction link can be encoded using a cipher, such as rot13, and transformed to: {“transact-link”: “uggcf://jjj.fbzr-gqf.pbz/genafnpg-erpbeq?vq=05p8on95-4946-43o3-8773-18qn302o683s”}. A QR code generator software can then be used to create the depicted QR code associated with the encoded transaction link.

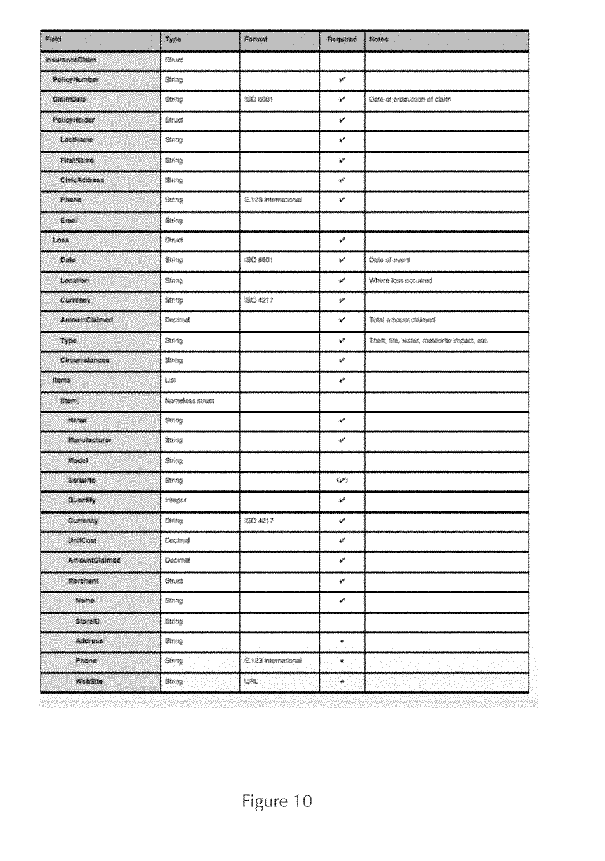

FIG. 10 illustrates by way of example embodiment a list of electronic claim fields. Types of fields can include structured, strings, lists and decimals. Claim fields can include but are not limited to: policy number; claim date; policy holder information (last name, first name, civic address, phone number, email address); type of loss (fire, theft, damage, water); police report information; loss information (date, location, currency, total amount claimed, circumstances of the incident; thing information (name, manufacturer, model, serial number, quantity, currency unit cost, amount claimed); and merchant information (name, store ID, address, phone number, web site).

FIG. 11 illustrates an example of a transfer of a claim from the IMS to the insurance carrier Claims Service (ICCS). Both the IMS and the ICCS contain a processor and data storage, as defined above. These can be single task or general purpose processors and the storage can be local or distributed. The data storage can contain one or more databases. The IMS can compile the data fields from FIG. 6, along with other claims details such as a police report, into the claim report which can then be sent electronically to the ICCS for processing.

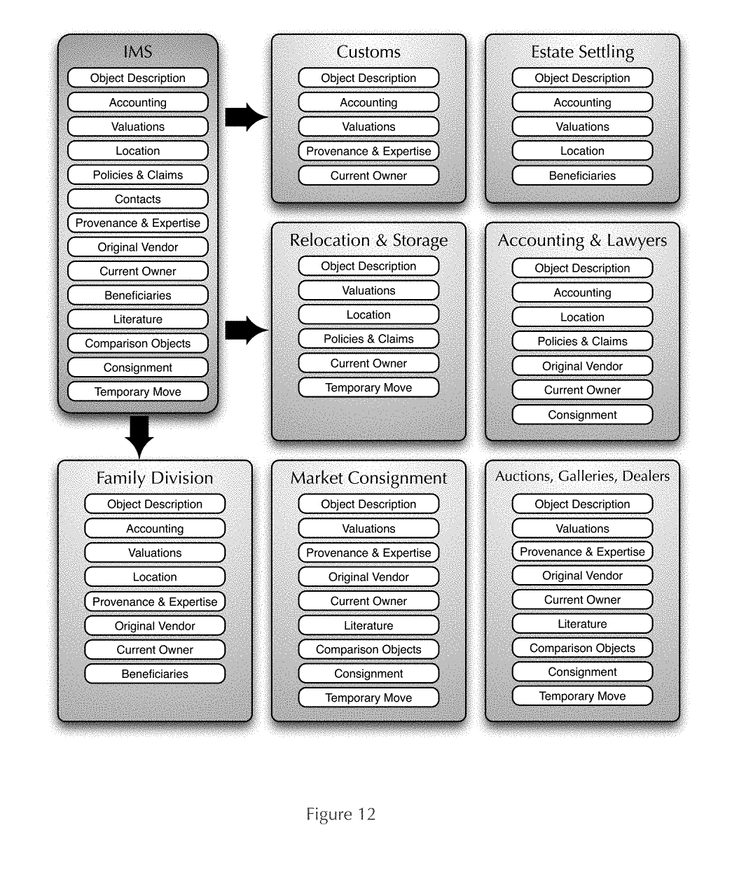

Although this system primarily relates to the insurance industry, other services can also benefit from it. FIG. 12 illustrates by way of example embodiment possible services that can benefit from the information contained in the IMS. Estate planning, for example, requires detailed information of things to be bequeathed, such as a description of the thing, related valuations, to whom the thing is bequeathed and when the thing passes to the beneficiary. The IMS can also include accounting details such as purchase price and associated costs. Accounting and law firms can benefit from the IMS when handling accounting, tax and estate affairs of the IMS owner. Auction houses, galleries and dealers can benefit from the IMS when handling the sale of things the IMS owner wishes to sell. When preparing papers for border crossings, customs agents can benefit, as will customs officers, when handling cross-border shipments. Trustees and/or lawyers involved with Family Division can benefit from the IMS when handling the IMS owner's instructions as to disposal of various things. Moving and storage companies can benefit from the IMS when packing, shipping, moving and/or storing things belonging to the IMS owner. Secondary market consignment companies can benefit from the IMS when handling things the IMS owner wishes to sell privately.

While certain implementations of the disclosed technology have been described in connection with what is presently considered to be the most practical and various implementations, it is to be understood that the disclosed technology is not to be limited to the disclosed implementations, but, on the contrary, is intended to cover various modifications and equivalent arrangements included within the scope of the appended claims. Although specific terms are employed herein, they are used in a generic and descriptive sense only and not for purposes of limitation.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams do not have to be performed in the order presented or if at all, according to some implementations of the disclosed technology.

These computer program instructions can also be stored in a non-transient computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

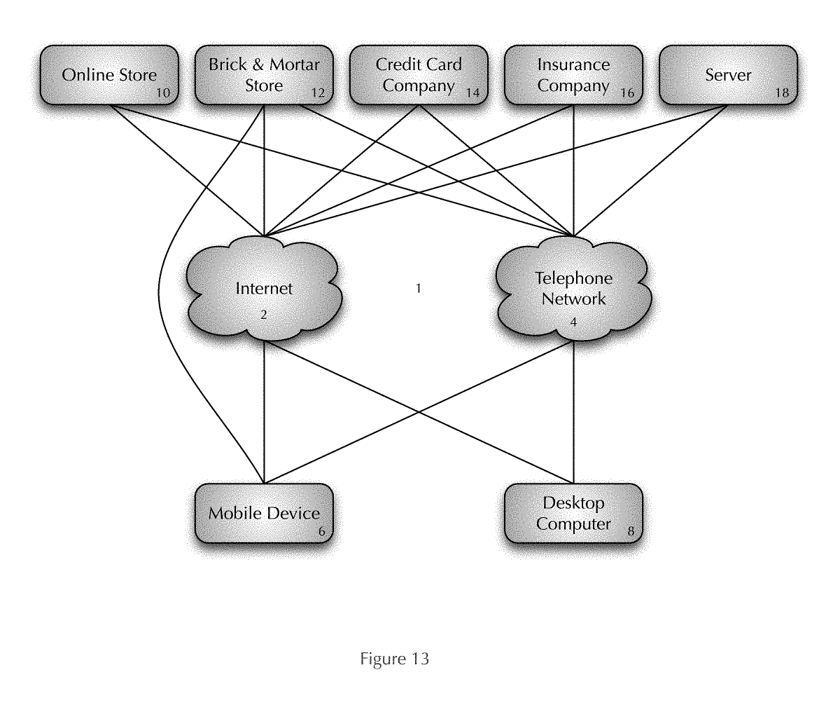

FIG. 13 describes an example of a system 1. The system 1 comprises mobile user interface devices 6, desk top computers 8, at least one server 18, online stores 10, brick-n-mortar stores 12, credit card companies 14, insurance companies 16, all interconnected via a communication network comprising the internet 2 and/or telephone network 4. All interconnections can be direct, indirect, wireless and/or wired as desired.

Various networks can be implemented in accordance with embodiments of the invention, including a wired or wireless local area network (LAN) and a wide area network (WAN), wireless personal area network (PAN) and other types of networks that comprise or are connected to the Internet. When used in a LAN networking environment, computers can be connected to the LAN through a network interface or adapter. When used in a WAN networking environment, computers typically include a modem, router, switch, or other communication mechanism. Modems can be internal or external, and can be connected to the system bus via the user-input interface, or other appropriate mechanism. Computers can be connected over the Internet, an Intranet, Extranet, Ethernet, or any other system that provides communications, such as by the network. Some suitable communications protocols can include TCP/IP, UDP, OSI, Ethernet, WAP, IEEE 802.11, Bluetooth, Zigbee, IrDa, WebRTC, or any other desired protocol. Furthermore, components of the system can communicate through a combination of wired or wireless paths, including the telephone networks.

The system 1 can be accessed via any user interface device 6 or desktop computer 8 that is capable of connecting to the server 18 via the internet 2 and/or telephone network 4. A plurality of user interface devices 6 or desktop computers 8 can be connected to the server 18. An example user interface device 6 contains a web browser and display. This includes user interface devices 6 such as internet connected televisions and projectors, tablets, iPads, Mac OS computers, Windows computers, e-readers, and mobile user devices such as the smartphones, iPhone, Android, and Windows Phone, and other communication devices. Preferably, the user interface device 6 is a smartphone. The smartphone can be in any form, such as a hand held device, wristband, or part of another device, such as vehicle.

The computer processing unit (CPU) of the user interface device 6 can be implemented as a conventional microprocessor, application specific integrated circuit (ASIC), digital signal processor (DSP), programmable gate array (PGA), or the like. The CPU executes the instructions that are stored in order to process data. The set of instructions can include various instructions that perform a particular task or tasks, such as those shown in the appended flowchart. Such a set of instructions for performing a particular task can be characterized as a program, software program, software, engine, module, component, mechanism, or tool. The memory can include random access memory (RAM), ready-only memory (ROM), programmable memory, flash memory, and the like. The memory, include application programs, OS, application data etc.

The server 18 described herein can include one or more computer systems directly connected to one another and/or connected over the network. Each computer system includes a processor, non-volatile memory, user input and user output mechanisms, a network interface, and executable program code (software) comprising computer executable instructions stored in non-transitory tangible memory that executes to control the operation of the server 18. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The server 18 can run any desired operating system, such as Windows, Mac OS X, Solaris or any other server based operating systems. Other embodiments can include different functional components. In addition, the present invention is not limited to a particular environment or server 18 configuration. Preferably, the server 18 is a cloud based computer system. If desired for the particular application, the server 18 or portions of the server 18 can be incorporated within one or more of the other devices of the system 1, including but not limited to a user interface device 6 or desktop computer 8.

The server 18 includes at least one web server and the query processing unit. The web server receives the user query and sends the user query to the query processing unit. The query processing unit processes the user query and responds back to the user interface device 6 via the web server. The query processing unit fetches data from the database server if additional information is needed for processing the user query. The database is stored in the non-volatile memory. The term “database” includes a single database and a plurality of separate databases. The server 18 can comprise the non-volatile memory or the server 18 can be in communication with the non-volatile memory storing the database. The database can be stored at different locations.

Software program modules and data stored in the non-volatile memory the server 18 and/or non-volatile memory of the user interface device 6 or desktop computer 8 can be arranged in logical collections of related information on a plurality of computer systems having associated non-volatile memories. The software and data can be stored using any data structures known in the art including files, arrays, linked lists, relational database tables and the like. The server 18, mobile user device 6, and/or desktop computer 8 can be programmed to perform the processes described herein.

Implementations of the disclosed technology can provide for a computer program product, comprising a computer-usable medium having a computer-readable program code or program instructions embodied therein, said computer-readable program code adapted to be executed to implement one or more functions specified in the flow diagram block or blocks. The computer program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Following is one example of a home inventory software application for user interface device, such as a smartphone or tablet.

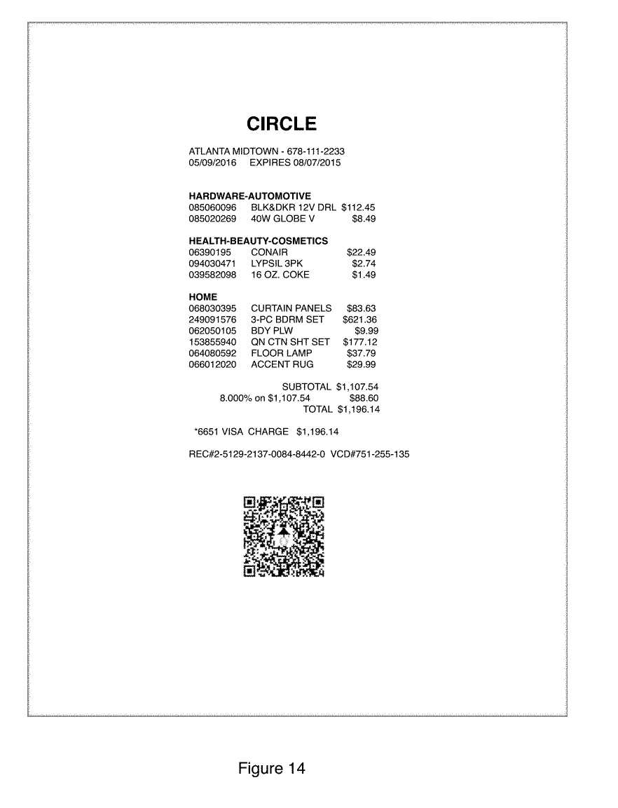

FIG. 14 illustrates a screenshot of an example of a paper receipt with a QR code embedded in it. The code can contain a URL link to the TDS, from which information which can include, but is not limited to, a description, an image, merchant contact, price, warranty, and manual, which can then be downloaded directly into the application.

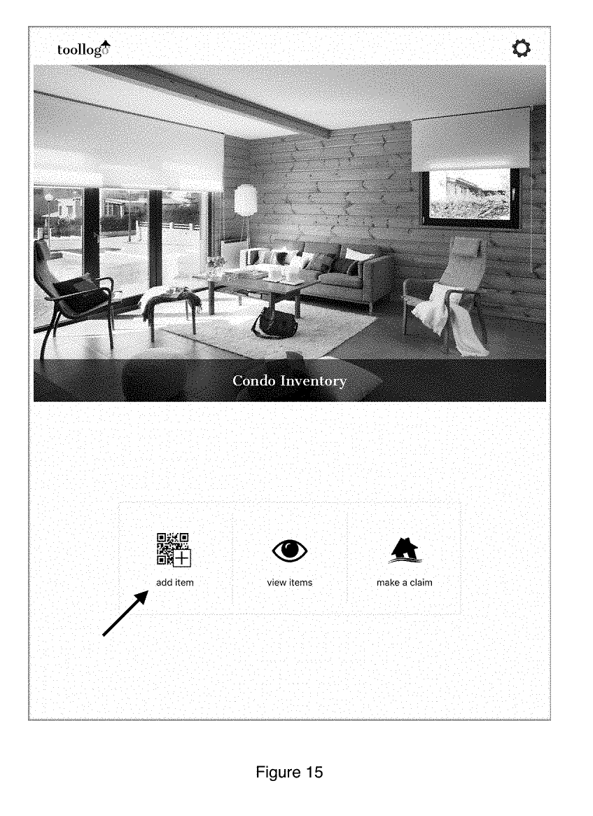

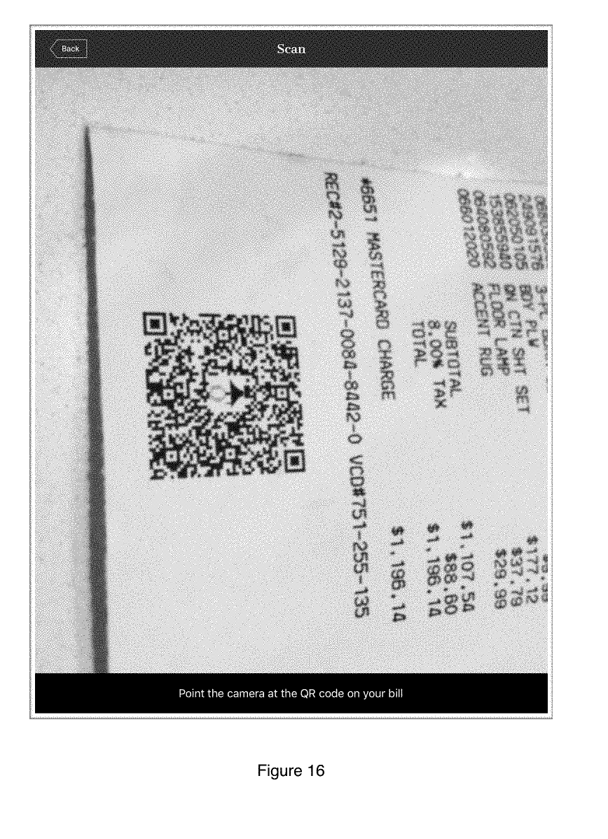

FIG. 15 illustrates a screenshot of an example of a home inventory software application, which includes, but is not limited to, the following icons: “add item”, “view items”, and “make a claim”. Tapping by the user on the “add item” icon can open up the device camera. By way of example, FIG. 16 illustrates a screenshot of the application capturing the information on a receipt QR code using a QR reader.

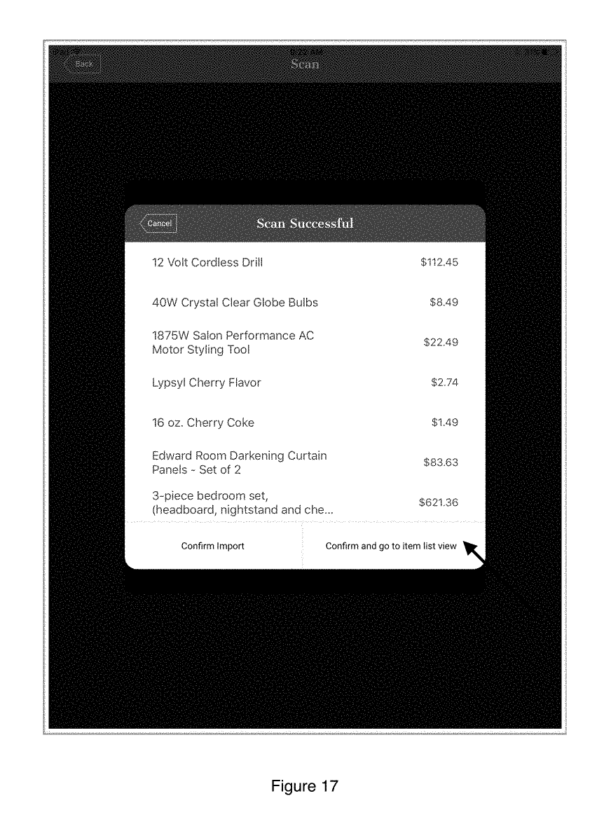

FIG. 17 illustrates a screenshot of an example list of purchased items downloaded from the receipt QR code, using the device QR code reader. The user can either “Confirm Import”, and return to the home screen; or “Confirm and go to item list view”.

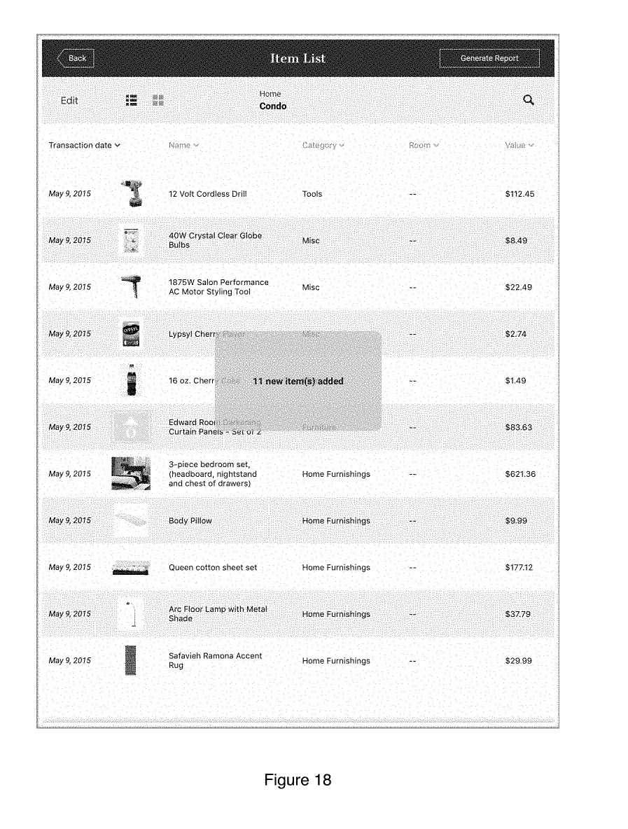

FIG. 18 illustrates a screenshot of the Item List after import has been confirmed. The application can disclose the number of new items added to the Item List.

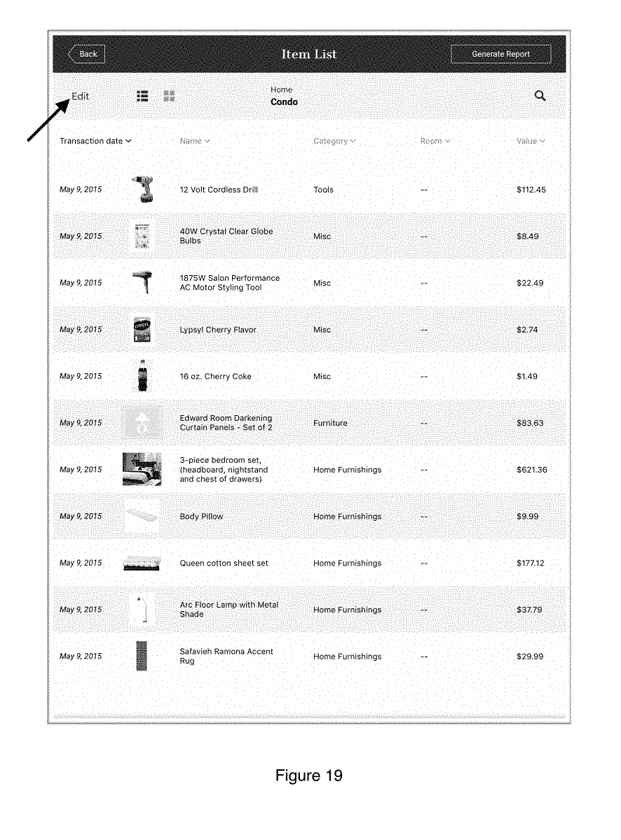

FIG. 19 illustrates a screenshot of an example Item List, containing, but not limited to, a transaction date, image, name, category, room and value. The list can contain items that are not to be included in the home inventory, such as consumables and services.

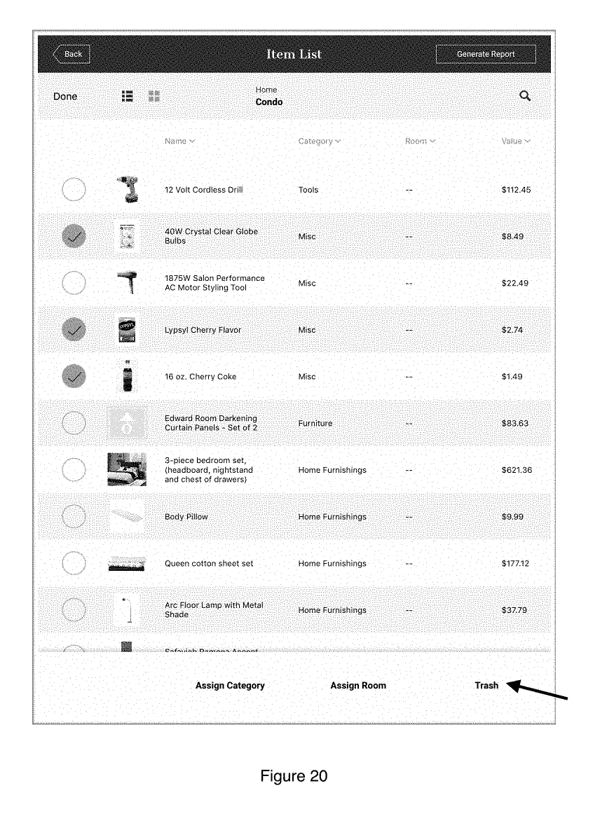

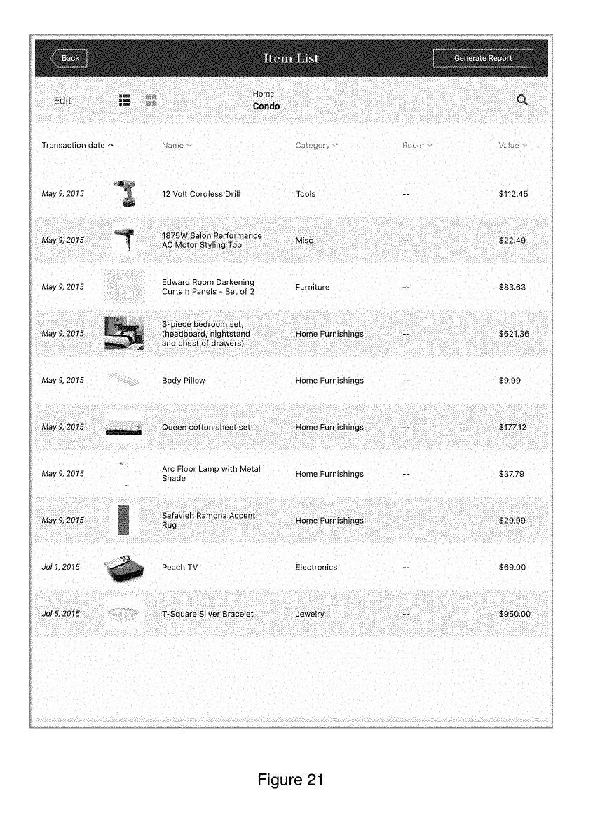

The “Edit” button can allow the user to select items to be removed from the Item List. FIG. 20 illustrates a screenshot of an example of selection and deletion of items not to be inventoried. Items can be selected by the user while in the “Edit” mode of the Item List and deleted by clicking on the “Trash” button. FIG. 21 illustrates a screenshot of an example updated Item List, with the deleted items no longer present.

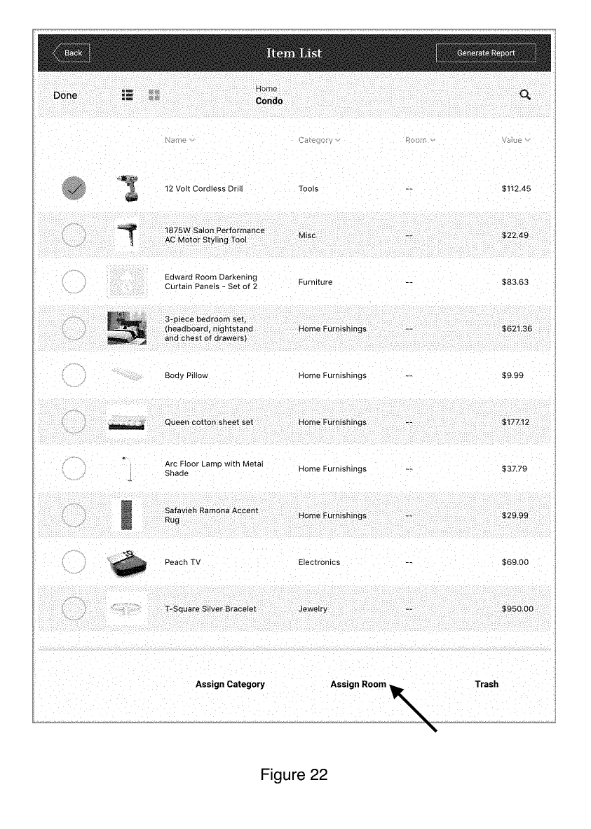

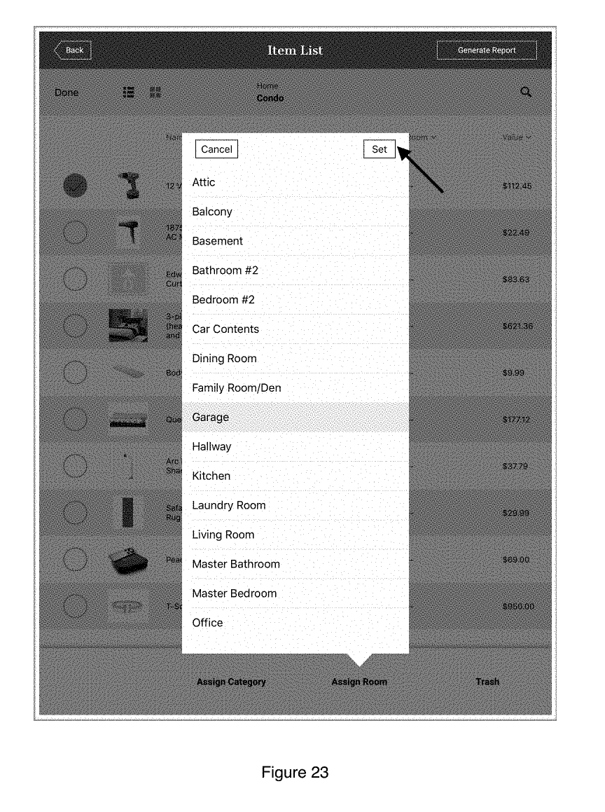

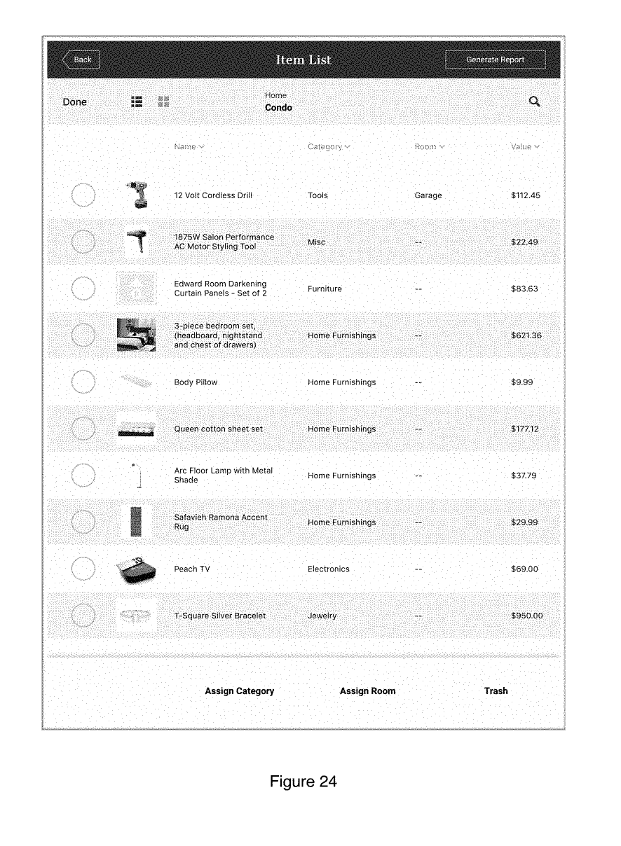

Items can be assigned to rooms once imported into the Item List. FIG. 22 illustrates a screenshot of an example of assigning a room to an item by the user clicking on “Assign Room”. FIG. 23 illustrates a screenshot of an example pop-up window, listing rooms from which the user can make a selection for the chosen item. In this particular case, selecting “Garage” and clicking on “Set” assigns the room “Garage” for the selected item, as demonstrated in the screenshot of FIG. 24.

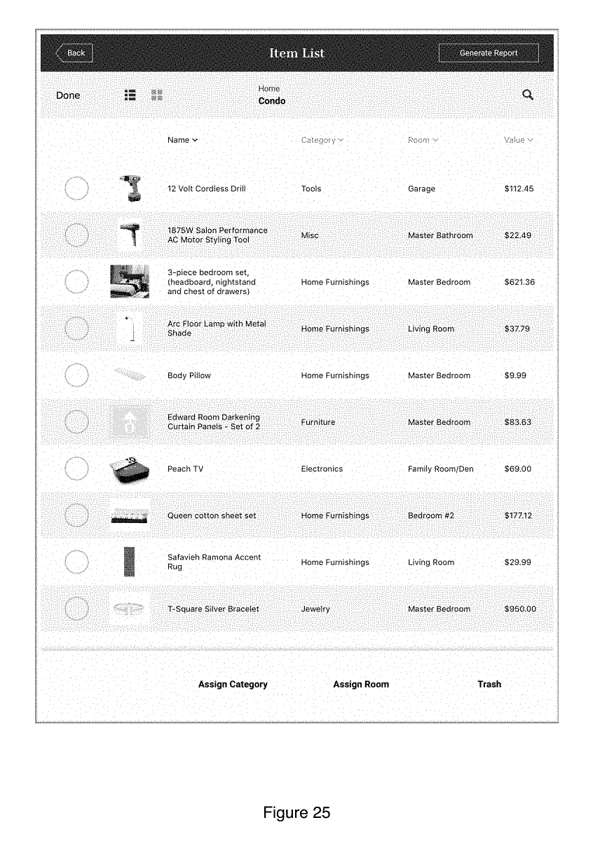

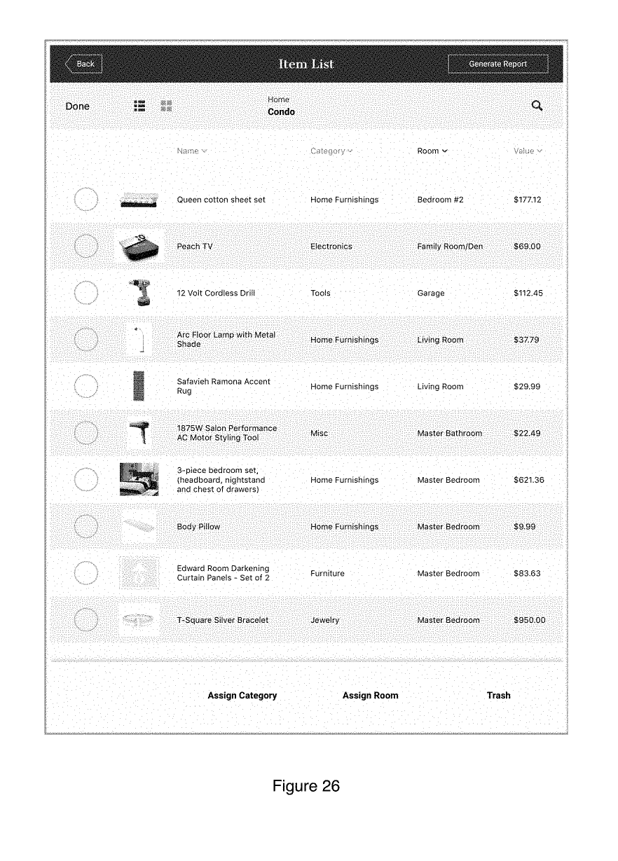

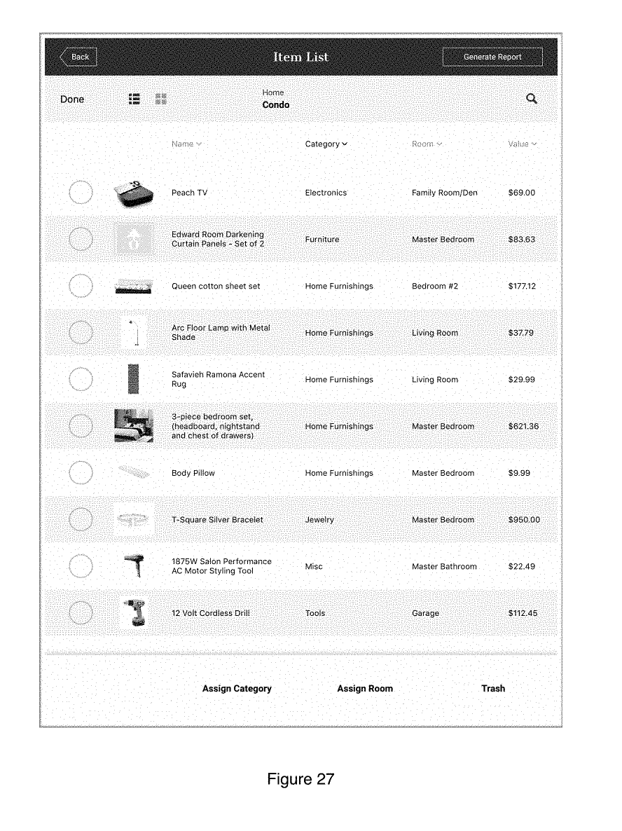

The application allows the “Item List” page to sort the items by, but not limited to, “Purchase Date”, “Name”, “Category”, “Room” or “Value”. By way of example, FIG. 25 illustrates a screenshot of an example of an unsorted Item List, FIG. 26 illustrates a screenshot of an example of items sorted by room, and FIG. 27 illustrates a screenshot of an example of items sorted by category.

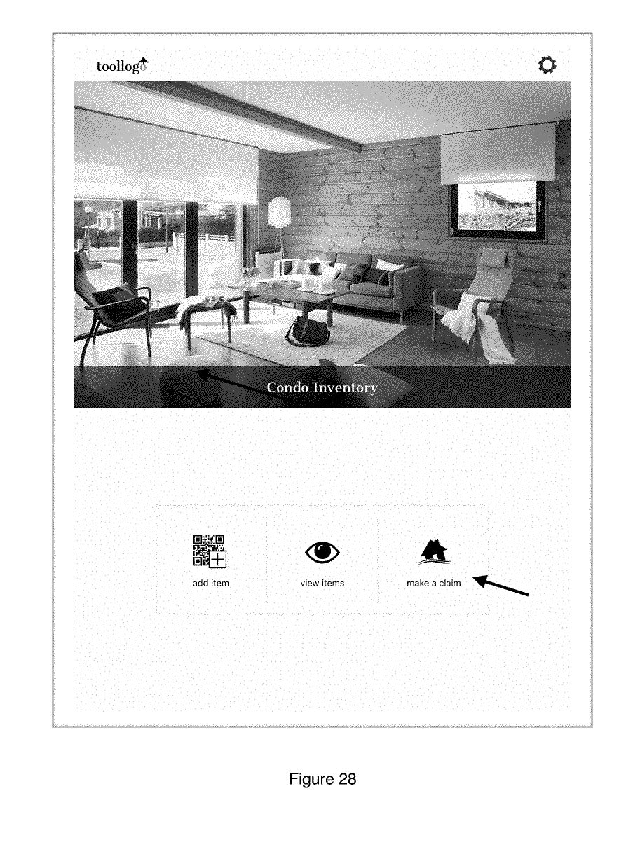

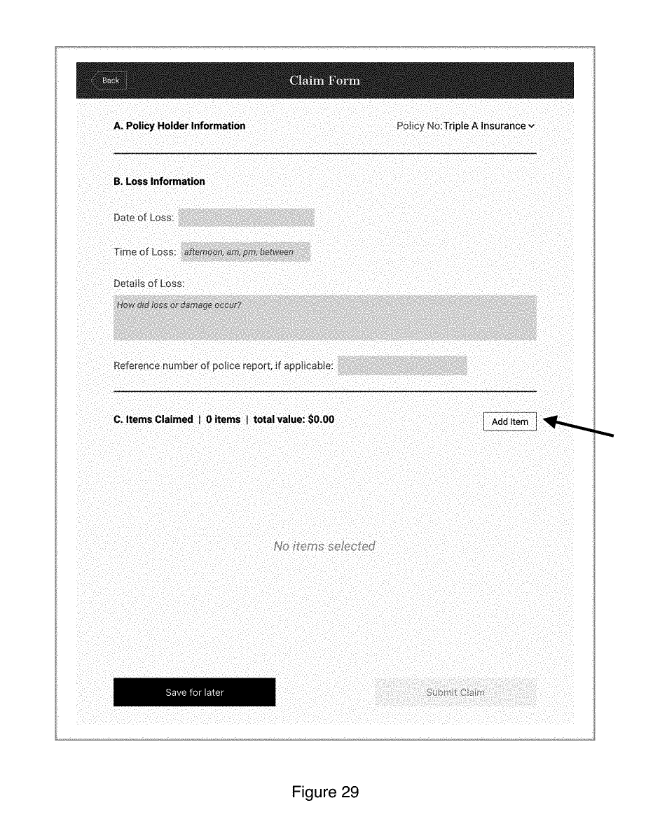

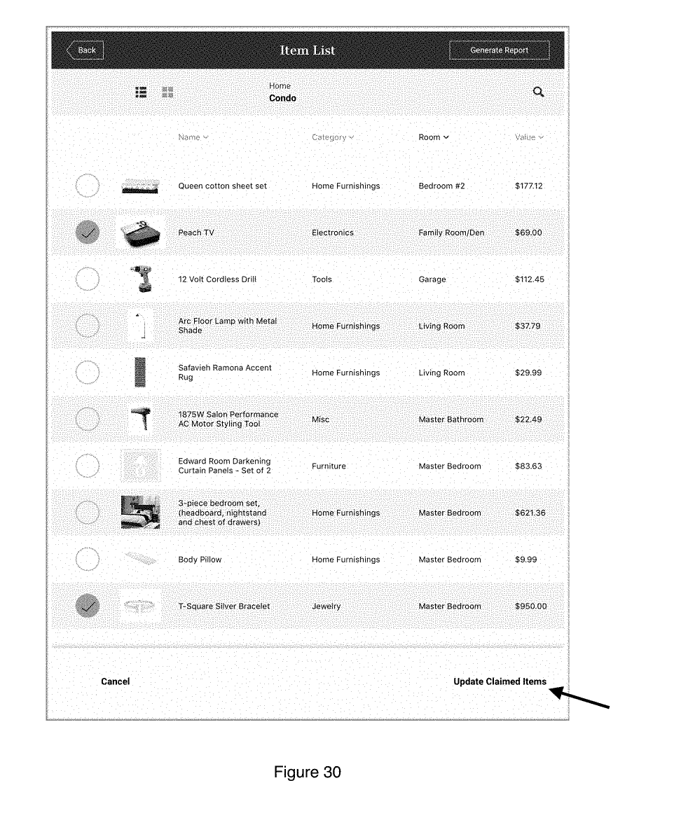

The home inventory application can also allow the user to prepare an insurance claim. FIG. 28 illustrates a screenshot of a user making an example selection of “make a claim” icon from the home page. The Claim Form, as illustrated by way of example in the screenshot of FIG. 29, can be completed by the user with information such as, but not limited to, Policy Number, Date of Event, Loss Information and Police Report Reference Number. Items claimed can be added by clicking on the “Add Item” button. The user can choose the items to be claimed from the Item List, and can click on the “Update Claimed Items” button, as shown by way of example in the screenshot of FIG. 30.

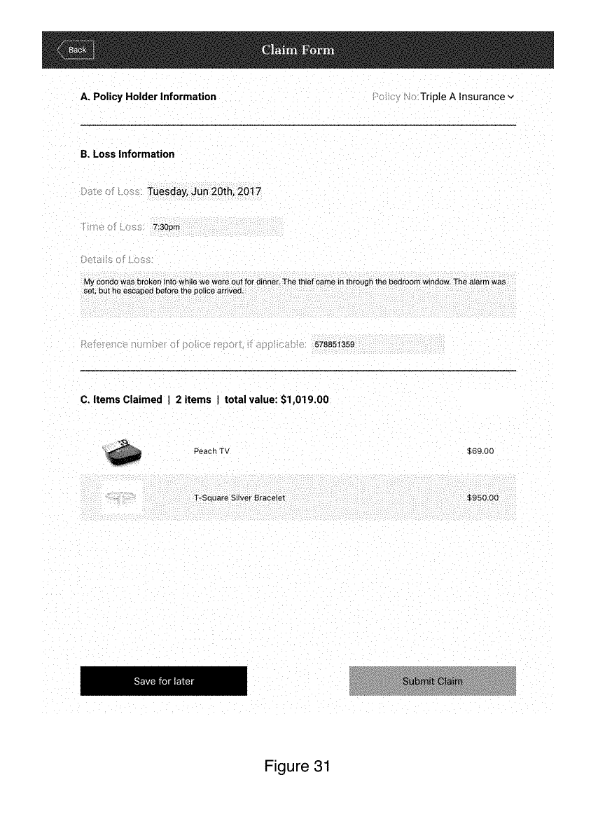

FIG. 31 illustrates a screenshot of an example Claim Form on which two items are being claimed. The application can, but is not limited to, tally the number of items claimed and the total value of the claim. The user can also add more items to the claim as necessary. Once the claim is completed, the user can click on the “Submit Claim” button.

The Claim Form can be sent by various methods to the insurance carrier, broker or agent: (1) electronically, through a PDF document; (2) electronically to the insurance carrier's server; (3) printing and mailing a copy of the Claim Form.

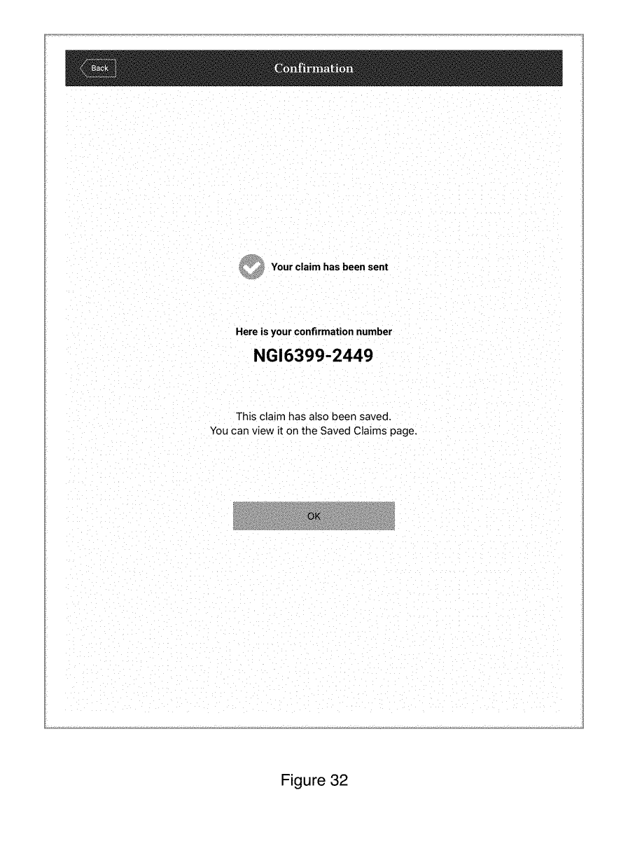

If the Claim Form is submitted electronically, the application can generate a confirmation number. FIG. 32 illustrates a screenshot of an example confirmation of a sent claim.

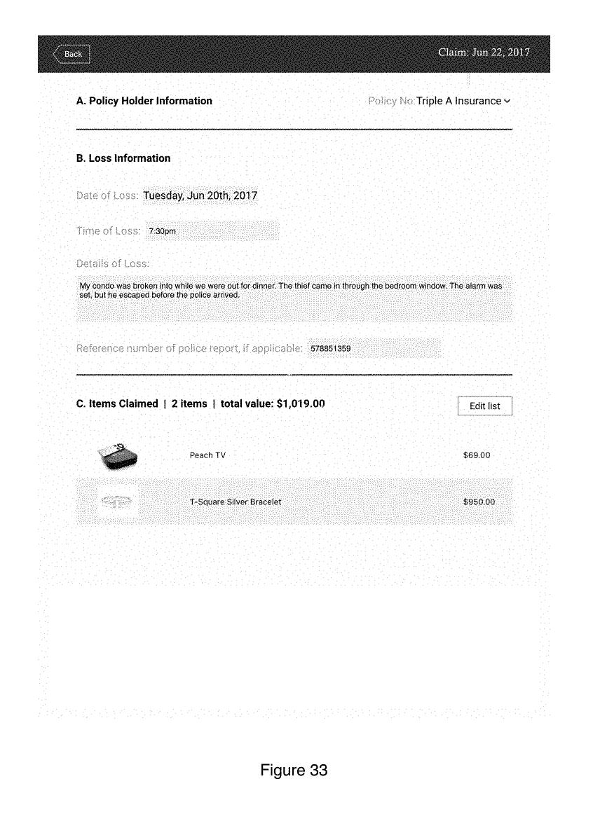

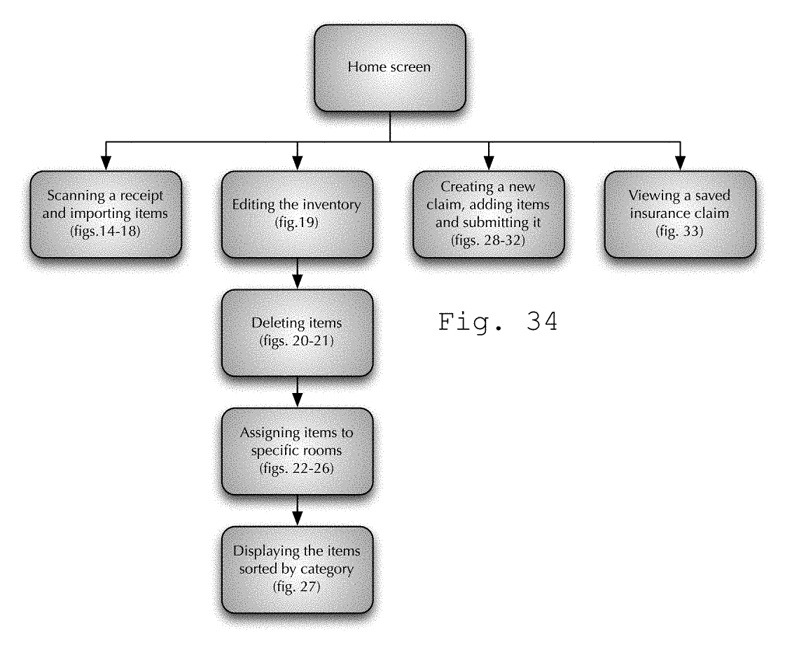

Notwithstanding the method of delivery to the insurance carrier, broker or agent, the claim can be saved and viewed on the Saved Claims page. FIG. 33 illustrates a screenshot of an example saved claim.

FIG. 34 illustrates a flow chart of the example method shown in FIGS. 14-33.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for automatically inventorying a purchased thing using an inventory management system in communication with at least one of a manufacturer of the thing, a merchant selling the thing, a credit card company processing the transaction for the thing, or a third-party service, wherein the inventory management system comprises a computer having a processor and a non-transient data storage, comprising the steps of:
receiving a transaction record at the inventory management system, wherein the transaction record comprises transaction information relating to the purchase of the thing as provided by the merchant;
optionally receiving a thing record at the inventory management system, wherein the thing record comprises generic information relating to the thing purchased as provided by the manufacturer, the merchant, the credit card company, or a third-party service; and
storing, within the non-transient data storage of the inventory management system, the received information from the transaction record and/or thing record, as part of an inventory.

2. The method of claim 1, further comprising the steps of:
storing the transaction record in a transaction database service, with a non-transient data storage;
storing the thing record in a thing information service, with a non-transient data storage;
providing a link to be used by the inventory management system to download the transaction record; and
providing a link in the transaction record to be used by the inventory management system to download the thing record.

3. The method of claim 1, wherein, as the result of damage or loss, a claim can be made to an insurance carrier, comprising the steps of:
using the processor and non-transient data storage of the inventory management system, generating an insurance claim related to the thing, in a format proscribed by an insurance carrier; and
transmitting the generated insurance claim to the insurance carrier.

4. The method of claim 1, further comprising the step of optionally receiving an insurance claim fulfillment report at the inventory management system, wherein the insurance claim fulfillment report comprises information relating to the settlement agreed upon by the insurance carrier.

5. A computer readable medium storing instructions in a non-volatile memory executable by the computer, wherein execution in the instructions implements a method according to claim 1.

6. An automatic inventory management and insurance claim system comprising:
at least one user interface device comprising a display, a processor and non-transitory memory, and being constructed to communicate with a network;
at least one merchant, the merchant selling at least one thing;
at least one insurance company in communication with the network; and
at least one server comprising a processor and non-transitory memory in communication with the network, wherein the server and/or user interface device being constructed for automatically obtaining information regarding the at least one thing when purchased from the merchant by a user using the user interface device, the non-transitory memory of the server and/or user interface device being constructed for automatically storing a thing record comprising the information, and the user interface and/or server being constructed to prepare and submit a claim comprising the thing record to the insurance company when the at least one thing is lost, damaged or stolen.

7. The system according to claim 6, wherein the merchant is in communication with the network.

8. The system according to claim 6, wherein the network comprises internet or telephone network.

9. The system according to claim 6, wherein the user interface device is a smartphone.

10. The system according to claim 6, wherein the user interface device is constructed to read the thing information from a purchase receipt from the merchant.

11. The system according to claim 6, wherein the user interface device and/or server is constructed to obtain the thing information from a manufacturer of the thing.

12. A method for automatically producing an inventory of purchased things and insurance claim comprising:
purchasing, by a user, a thing from a merchant and obtaining a receipt for the purchased thing;
using, by the user, a user interface device comprising a display, a processor and non-transitory memory, and being constructed to communicate with a network, to obtain information regarding the purchased thing from at least one of the receipt, the merchant, a manufacturer of the thing, or a third-party; and
storing, by the user interface device, a thing record comprising the information regarding the purchased thing in the non-transitory memory of the user interface device and/or non-transitory memory of a server connected to the network to provide an inventory of purchased things.

13. The method according to claim 12, comprising displaying a list of things from the receipt on the display, selecting by the user one or more things from the list to be stored in the inventory and deleting things from the list that are not to be stored in the inventory.

14. The method according to claim 13, further comprising providing a list of rooms by the user interface device and the user selecting a room and selecting things to be associated with the selected room.

15. The method according to claim 12, further comprising encrypting transaction records.

16. The method according to claim 12, further comprising preparing and submitting, by the user interface and/or server, a claim comprising the thing record to an insurance company when the thing is lost, damaged or stolen.

17. The method according to claim 12, wherein the merchant is in communication with the network.

18. The method according to claim 12, wherein the network comprises internet or telephone network.

19. The method according to claim 12, wherein the user interface device is a smartphone.

20. The method according to claim 12, wherein the user interface device obtains the thing information from a purchase receipt from the merchant.

21. The method according to claim 12, wherein the user interface device and/or server is obtains the thing information from a manufacturer of the thing.
